(19) United States
(12) Patent Application Publication
(10) Pub. No.: US 2011/0090617 A1
(43) Pub. Date: Apr. 21, 2011

(54) CAPACITOR ELECTRODE, CAPACITOR STRUCTURE AND METHOD OF MAKING THE SAME

(76) Inventors: Shin-Bin Huang, Hsinchu County (TW); Chung-Lin Huang, Taoyuan County (TW)

(21) Appl. No.: 12/686,399

(22) Filed: Jan. 13, 2010

(30) Foreign Application Priority Data
Oct. 16, 2009 (TW) 098135095

(51) Int. Cl. H01G 4/005; H01G 4/00

(52) U.S. Cl. 361/303; 427/79; 216/13

(57) ABSTRACT

A method of fabricating a capacitor electrode. A stack structure is formed on a substrate, and the stack structure includes a first conductive layer, a first sacrificial layer, and a second sacrificial layer. The stack structure includes a first sidewall and a second sidewall facing the first sidewall. A conductive sidewall is formed on the first sidewall and the second sidewall to electrically connect the first conductive layer to the second conductive layer. Finally, the first and the second sacrificial layers are removed.

### BACKGROUND OF THE INVENTION

1. Field of the Invention

The present invention relates to a capacitor electrode, more particularly to a capacitor electrode capable of providing high capacitance and the method of making the same.

2. Description of the Prior Art

Miniaturization constitutes a continuing interest in designing and fabricating semiconductor devices. For example, it can be advantageous to decrease the size of memory cells used in integrated circuit memory devices.

A conventional DRAM is composed of a transistor and a capacitor. The capacitor has a top electrode, a bottom electrode and a capacitor dielectric layer positioned between the top and bottom electrodes. When a voltage potential difference exists between the two electrodes, an electric field is present in the dielectric. This field stores energy.

A capacitance of an ideal capacitor is defined as

C=KA/D eq. (1)

K is the dielectric constant of the capacitor dielectric layer. A is the area of the electrodes. D is the separation of the top electrode and the bottom electrode. Therefore, the equation (1) reveals that capacitance increases with area and dielectric constant.

To increase the capacitance without increasing the size of a DRAM cell, one way is to use high-k material as the capacitor dielectric. The other way is to increase the area of the electrode by building the stack electrodes. Traditional methods of forming the stack electrode may increase the area of the electrode, however, such methods may be complicated and time-consuming.

Accordingly, a need exists in the art for capacitor electrode designs and fabrication methods that increase electrode area without unnecessarily complicating process flows.

### SUMMARY OF THE INVENTION

In light of above-mentioned problem, the present invention provides an improved capacitor electrode structure and a method of making the capacitor electrode structure.

According to a preferred embodiment of the presenting invention, a method of fabricating capacitor electrode includes: providing a substrate. Then, a stack structure is formed on the substrate, wherein the stack structure comprises a first conductive layer, a first sacrificial layer, a second conductive layer and a second sacrificial layer, and the stack structure comprises a first sidewall and a second sidewall facing to the first sidewall. Next, a conductive sidewall is formed on the first sidewall and the second sidewall so as to connect the first conductive layer to the second conductive layer electrically. Finally, the first sacrificial layer and the second sacrificial layer are removed.

According to another embodiment of the presenting invention, a capacitor electrode structure is provided. A capacitor electrode structure includes: a first conductive layer having a first edge and a second edge, a second conductive layer parallel to the first conductive layer and having a third edge and a fourth edge, a first conductive sidewall contacting the first edge and the third edge to connect the first conductive layer to the second conductive layer electrically and a second conductive sidewall contacting the second edge and the fourth edge to connect the first conductive layer to the second conductive layer electrically.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 to FIG. 11 depict a method of fabricating a capacitor electrode schematically.

FIG. 12 depicts a sectional view of a method of fabricating a capacitor schematically.

FIG. 13 depicts a capacitor structure of the present invention schematically.

### DETAILED DESCRIPTION

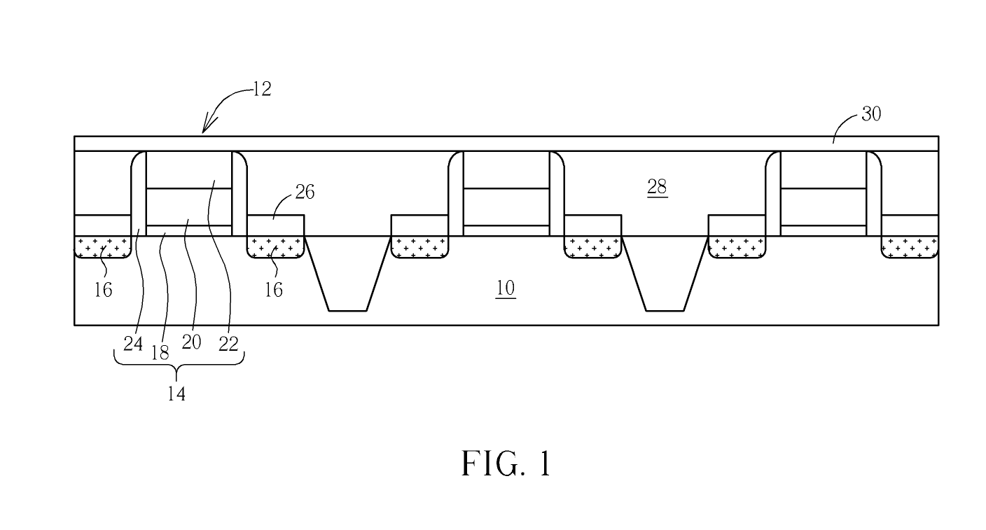

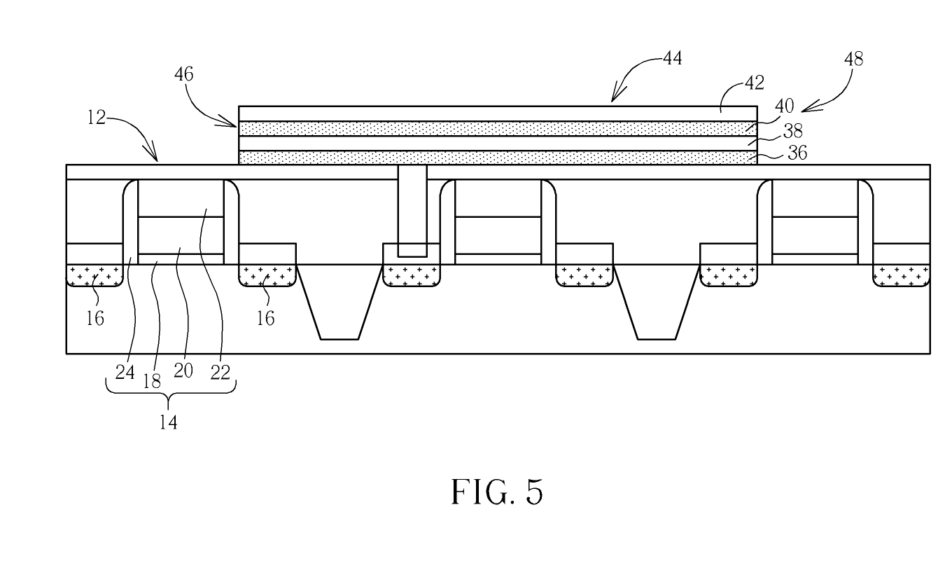

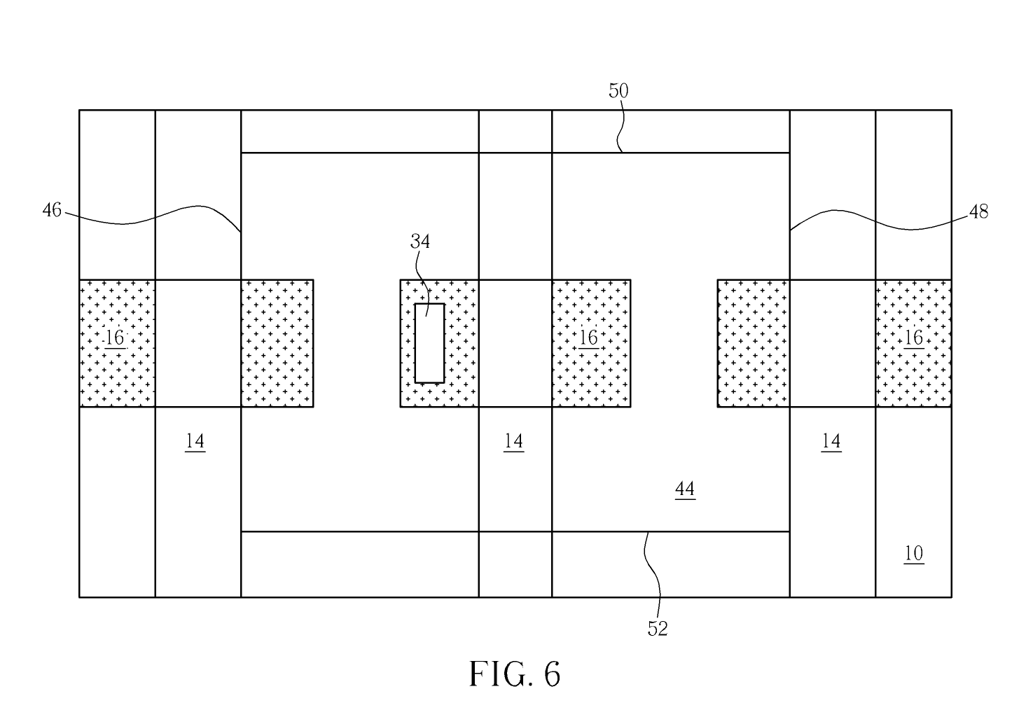

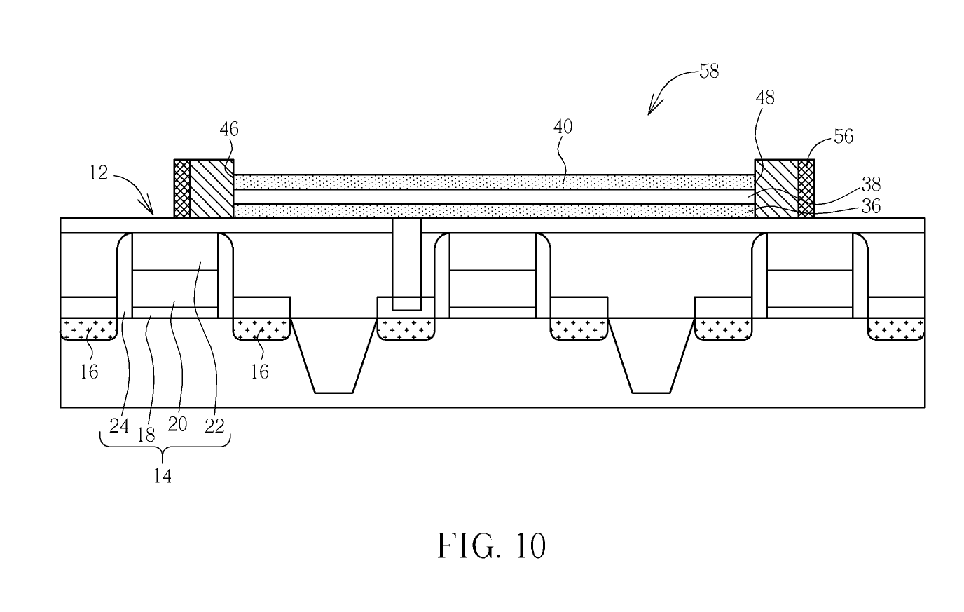

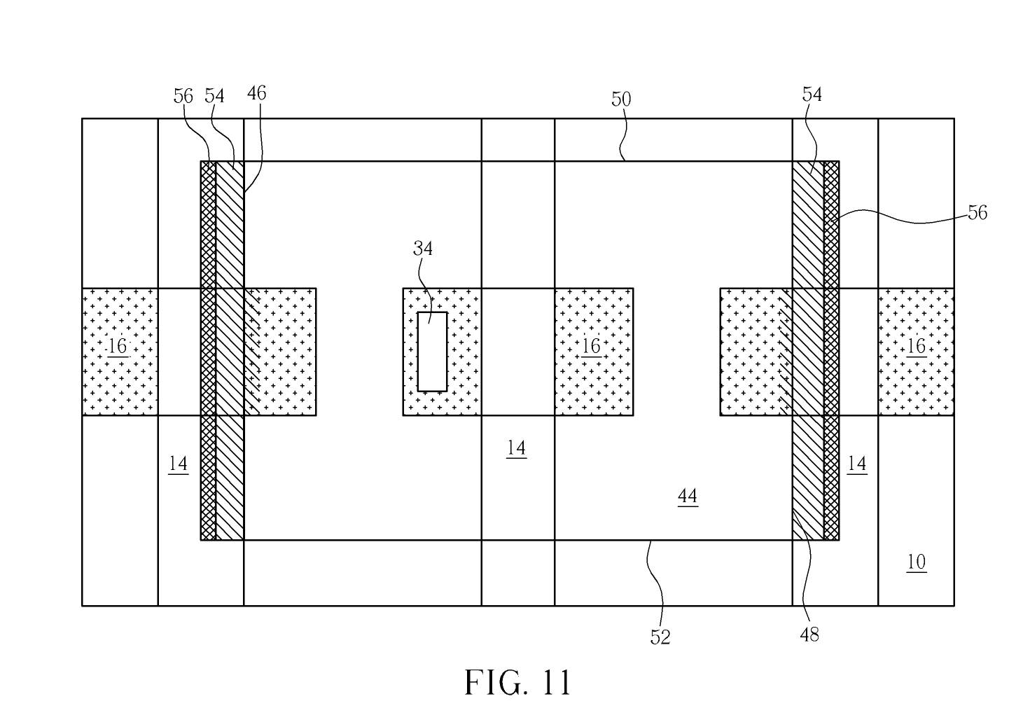

FIG. 1 to FIG. 11 depict a method of fabricating a capacitor electrode schematically, wherein FIG. 6 is the top view of the stack structure in FIG. 5. FIG. 11 is the top view of the capacitor electrode in FIG. 10.

As shown in FIG. 1, a substrate 10 having a metal oxide semiconductor (MOS) transistor 12 is provided. The MOS transistor 12 includes a gate 14, a source/drain doping region 16. The gate 14 includes a gate dielectric layer 18, a gate conductor 20 positioned on the gate dielectric layer 18, a gate cap layer 22 disposed on the gate conductor 20 and a spacer 24 positioned on the sidewall of the gate dielectric layer 18, the gate conductor 20 and the gate cap layer 22. An epitaxial silicon layer 26 may be optionally positioned on the substrate 10 where the source/drain doping region 16 resides. The epitaxial silicon layer 26 can decrease the sheet resistance between the source/drain doping region 16 and the contact plug formed afterwards. Next, a dielectric layer 28 is formed on the substrate 10. The dielectric layer 28 may be phosphosilicate glass (PSG) or other chemical compounds of silicon oxide. The top surface of the dielectric layer 28 is substantially aligned with the top surface of the gate 14. Later, a dielectric layer 30 such as a silicon nitride layer is formed to cover the dielectric layer 28.

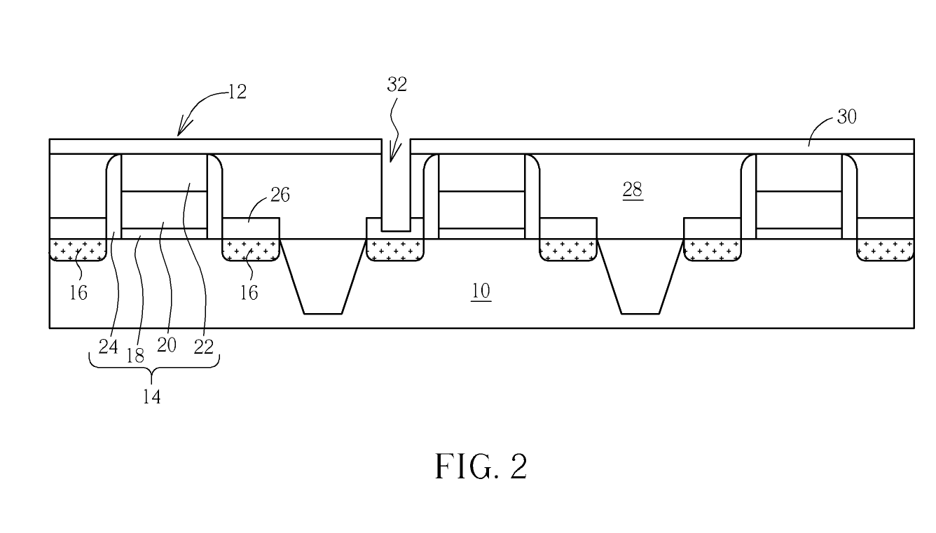

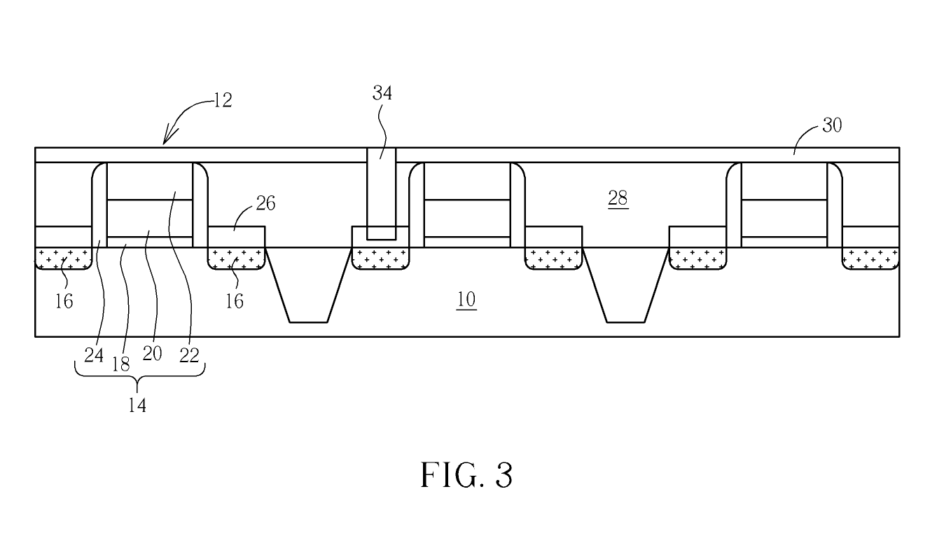

As shown in FIG. 2, a contact hole 32 is formed in the dielectric layers 28, 30 and the contact hole 32 is disposed directly on the top of the source/drain doping region 16. As shown in FIG. 3, a conductive layer is formed in the contact hole to serve as a contact plug 34 connecting the source/drain doping region 16 electrically. The contact plug 34 may be made of titanium nitride, titanium or other conductive materials.

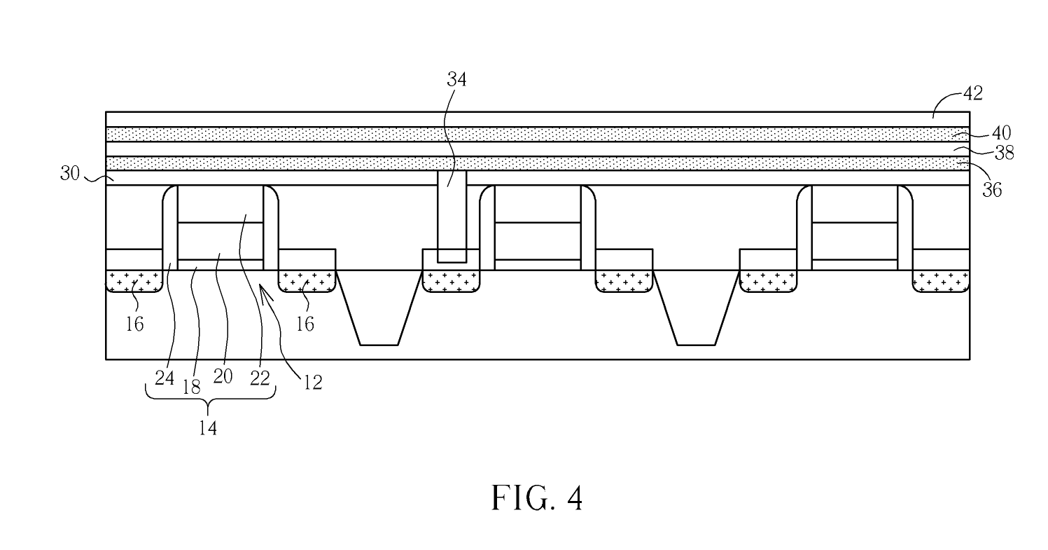

Please refer to FIG. 4, a first conductive layer 36, a first sacrificial layer 38, a second conductive layer 40 and a second sacrificial layer 42 are formed from bottom to top on the dielectric layer 30. The first conductive layer 36 connects to the contact plug 34 electrically.

As shown in FIG. 5, a lithographic process is performed to remove the first conductive layer 36, the first sacrificial layer 38, the second conductive layer 40 and the second sacrificial layer 42 partly so as to form a stack structure 44. Please refer to both FIG. 5 and FIG. 6, the stack structure 44 includes a first sidewall 46, a second sidewall 48, a third sidewall 50 and a fourth sidewall 52. The first sidewall 46 faces the second sidewall 48, and the third sidewall 50 faces the fourth sidewall 52. The first sidewall 46 is adjacent to the third sidewall and the fourth sidewall 52. The first conductive layer 36 and the second conductive layer 40 can be made of titanium nitride, aluminum, copper, silicides or other conductive materials. The first sacrificial layer 38 and the second sacrificial layer 42 can be selected from the group consisting of phosphosilicate glass, borophosphosilicate glass and other chemical compounds of silicon oxide. Furthermore, the stack structure 44 is not limited to only include four material layers (the first conductive layer 36, the first sacrificial layer 38, the second conductive layer 40, and the second sacrificial layer 42) mentioned above. The stack structure 44 can be customized to include more conductive layers and sacrificial layers.

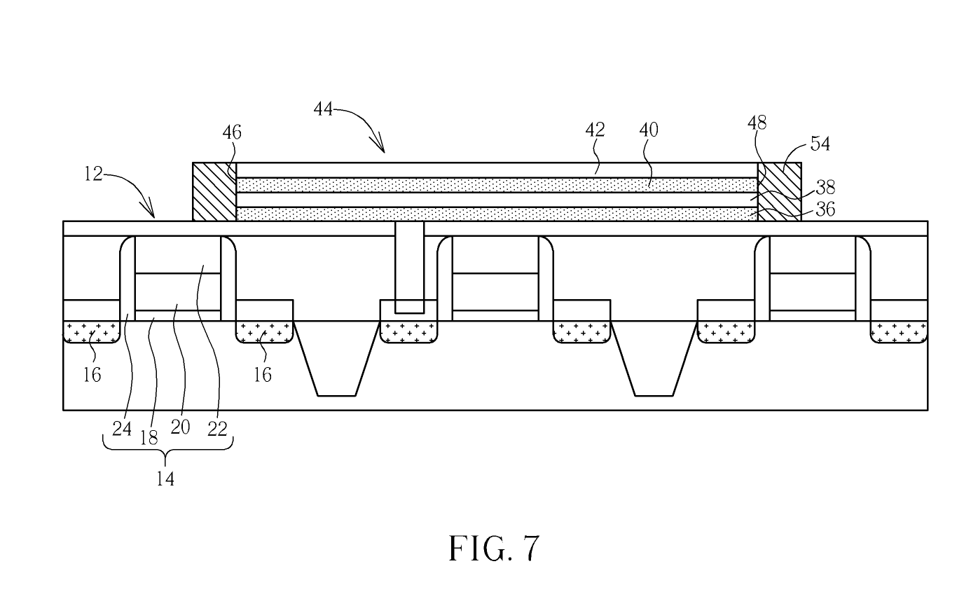

As shown in FIG. 7, a conductive material layer (not shown) is formed to conformally cover the stack structure 44 and the dielectric layer 30. The conductive material layer can be titanium nitride, aluminum, copper, silicides or other conductive materials. According to a preferred embodiment of the present invention, the conductive material layer can be made of the same material as the first conductive layer 36 or the second conductive layer 38.

Then, an anisotropic etching is performed to remove the conductive material layer on the top surface of the stack structure 44 and the substrate 10. The reminding conductive material layer on the first sidewall 46, the second sidewall 48, the third sidewall 50, and the fourth sidewall 52 serves as a conductive sidewall 54.

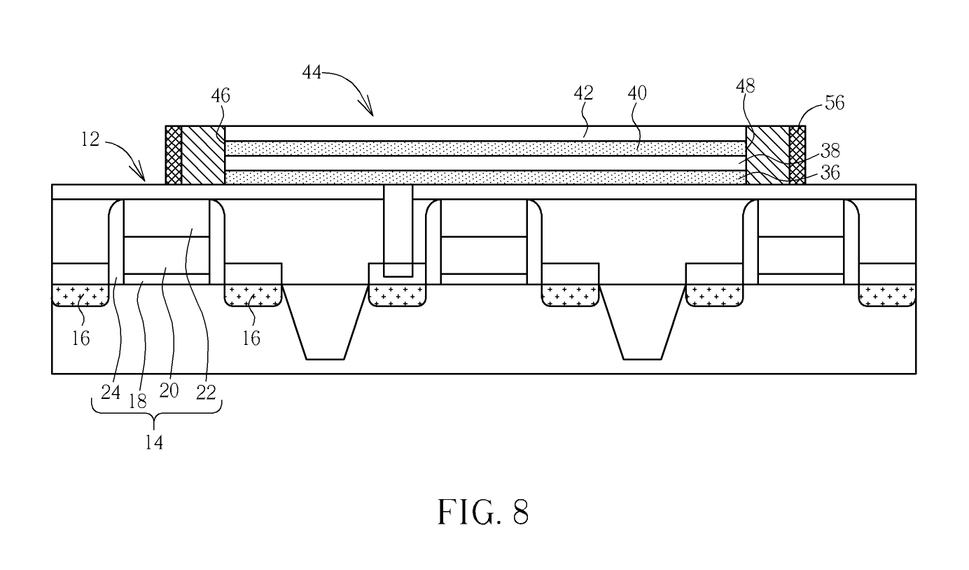

As shown in FIG. 8, a polysilicon layer is formed on the stack structure 44, the conductive sidewall 54 and the dielectric layer 30 conformally. Later, another anisotropic etching is performed to remove the polysilicon layer on the top surface of the stack structure 44 and the substrate 10. The reminding polysilicon layer on the first sidewall 46, the second sidewall 48, the third sidewall 50 and the fourth sidewall 52 will be called a polysilicon structure 56 in the following description.

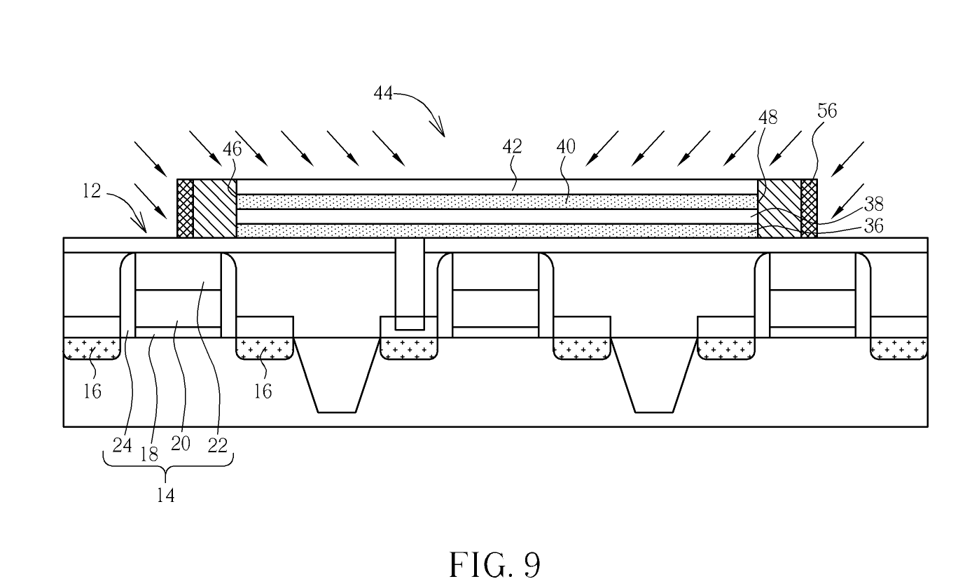

As shown in FIG. 9, a titled implantation process is performed to the polysilicon structure 56 on the first sidewall 46 and on the second sidewall 48. The titled implantation process is performed by implanting at least one element such as boron into the polysilicon structure 56. Then a wet etching process is performed by using ammonia solution to remove the polysilicon structure 56 which is not bombarded by the elements. In other words, the polysilicon structure 56 on the third sidewall 50 and fourth sidewall 52 is removed, and the conductive structure 54 on the third sidewall 50 and fourth sidewall 52 is exposed. Next, the conductive structure 54 on the third sidewall 50 and fourth sidewall 52 is removed by the ammonium peroxide mixture (APM) . Since the conductive structure 54 on the third sidewall 50 and fourth sidewall 52 is removed, the stack structure 44 is not a closed structure, and the etching solution can flow into the stack structure to remove material layers. In this embodiment, the first sacrificial layer 38 and the second sacrificial layer 42 are removed. At this point, the capacitor electrode 58 of the present invention is completed.

It is noteworthy that the angle of the element in the titled implantation process can be controlled to only bombard on the polysilicon layer 56 on the first sidewall 46. As a result, only the conductive sidewall 54 on the first sidewall 46 is removed, and the capacitor electrode 58 therefore has three conductive sidewalls 54. Alternatively, only the conductive sidewall 54 on the first sidewall 46 and the third sidewall 50 is removed. So the capacitor electrode 58 will have two adjacent conductive sidewalls 54 on the second sidewall 48 and the fourth sidewall 52.

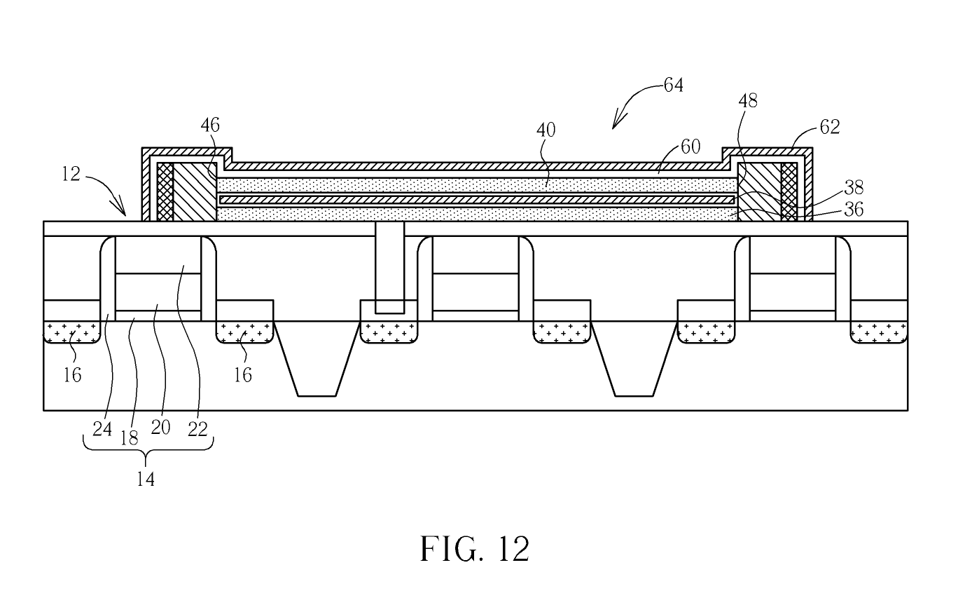

FIG. 12 depicts a sectional view of a method of fabricating a capacitor. As shown in FIG. 12, after the capacitor electrode is completed, a capacitor dielectric layer 60 is formed to cover the first conductive layer 36, the second conductive layer 40, the conductive sidewall 54 and the polysilicon structure 56 on the first sidewall 46, and on the second sidewall 48. The capacitor dielectric layer 60 can be silicon oxide, silicon nitride, silicon oxynitride, tantalum oxide or zirconium oxide. The capacitor dielectric layer 60 can be formed by chemical vapor deposition (CVD), physical vapor deposition (PVD), or atomic layer deposition (ALD). Next, a third conductive layer 62 is formed to encapsulate the capacitor dielectric layer 60 and serves as another capacitor electrode. The third conductive layer 62 can be made of titanium nitride, aluminum, copper, silicides or other conductive materials. The third conductive layer 62 is preferably formed by CVD, PVD, or ALD. At this point, the capacitor structure 64 is completed.

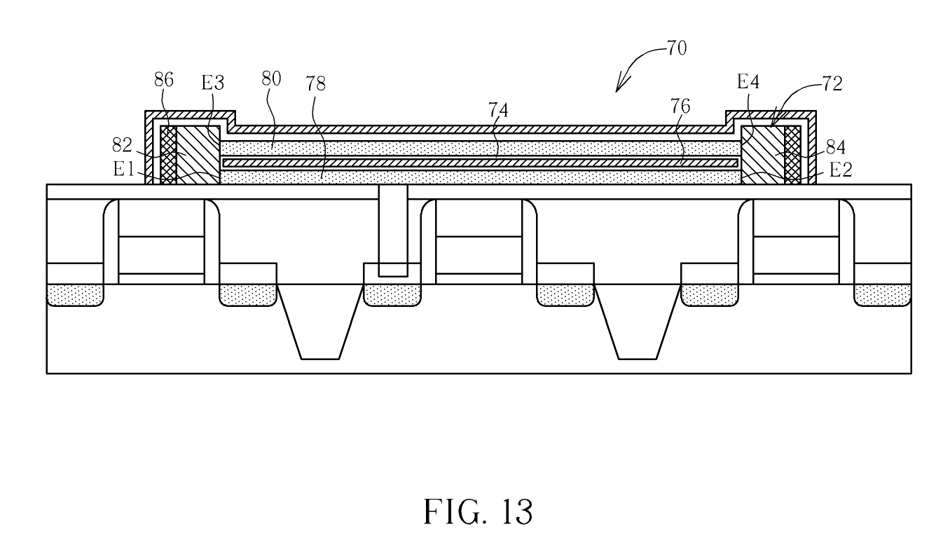

FIG. 13 depicts a capacitor structure of the present invention schematically. As shown in FIG. 13, a capacitor structure 70 includes a first capacitor electrode 72, a capacitor dielectric layer 74 and a second capacitor electrode 76. The first capacitor electrode 72 includes a first conductive layer 78, a second conductive layer 80 disposed parallel to the first conductive layer 78. The first conductive layer 78 has a first edge E1 and a second edge E2, and the second conductive layer 80 has a third edge E3, and a fourth edge E4. A first conductive sidewall 82 contacts the first edge E1 and the second edge E2. Therefore, the first conductive layer 78 and the second conductive layer 80 connect to each other electrically through the first conductive sidewall 82. A second conductive sidewall 84 contacts the second edge E2 and the fourth edge E4 so as to connect the first conductive layer 78 and the second conductive layer 80 electrically. The first conductive layer 78, the second conductive layer 80, the first conductive sidewall 82, and the second conductive sidewall 84 together form the first capacitor electrode 72. The first edge E1 can face the second edge E2 or be adjacent to the second edge E2. The third edge E3 can face the second edge E4 or be adjacent to the second edge E4. FIG. 13 shows the first edge E1 facing the second edge E2, and the third edge E3 facing the second edge E4 as example.

The position of the conductive sidewalls 82, 84 can be anywhere which can connect the first conductive layer 78 to the second conductive layer 80 electrically. Furthermore, there can be only the first conductive sidewall 82 on the first edge E1 and the second edge E3, the second conductive sidewall 84 can be omitted.

According to another preferred embodiment, a polysilicon structure 86 can be optionally disposed on the conductive sidewalls 82, 84. It is noteworthy that the first capacitor electrode 72 is not limited to the two conductive layers mentioned above. It may include multiple conductive layers numbering more than two.

The capacitor dielectric layer 74 covers the first conductive layer 78, the second conductive layer 80, the first conductive sidewall 82, the second conductive layer 84 and the polysilicon structure 86. The second capacitor electrode 76 encapsulates the capacitor dielectric layer 74 and fills up the gap between the first conductive layer 78 and the second conductive layer 80.

The first conductive layer 78, the second conductive layer 80, the first conductive sidewall 82, the second conductive sidewall 84, and the second capacitor electrode 76 can be individually selected from the group consisting of titanium nitride, aluminum, copper, silicides and other conductive materials. Preferably, the first conductive layer 78, the second conductive layer 80, the first conductive sidewall 82 and the second conductive sidewall 84 are made of the same material. The capacitor dielectric layer 74 can be silicon oxide, silicon nitride, silicon oxynitride, tantalum oxide or zirconium oxide.

The capacitor electrode of the present invention has multiple conductive layers which are parallel to each other. Furthermore, the aforesaid conductive layers are connected to each other electrically through at least a conductive sidewall. Moreover, the capacitor dielectric layer covers the conductive sidewall and the parallel conductive layers. Another capacitor electrode fills the gaps between the parallel conductive layers and encapsulates the capacitor dielectric layer.

Those skilled in the art will readily observe that numerous modifications and alterations of the device and method may be made while retaining the teachings of the invention.

What is claimed is:

1. A method of fabricating capacitor electrode, comprising:
providing a substrate;
forming a stack structure on the substrate, wherein the stack structure comprises a first conductive layer, a first sacrificial layer, a second conductive layer and a second sacrificial layer, and the stack structure comprises a first sidewall and a second sidewall facing the first sidewall;
forming a conductive sidewall on the first sidewall and the second sidewall so as to connect the first conductive layer to the second conductive layer electrically; and
removing the first sacrificial layer and the second sacrificial layer.

2. The method of fabricating capacitor electrode of claim 1, wherein the stack structure further comprises a third sidewall and a fourth sidewall, the third sidewall faces the fourth sidewall, and the first sidewall is adjacent to the third sidewall.

3. The method of fabricating capacitor electrode claim 2, wherein when forming the conductive sidewall on the first sidewall and the second sidewall, the conductive sidewall is simultaneously formed on the top surface of the stack structure, the third sidewall, the fourth sidewall and the surface of the substrate.

4. The method of fabricating capacitor electrode of claim 3, further comprising:
after forming the conductive sidewall, and before removing the first sacrificial layer and the second sacrificial layer, etching the conductive sidewall anisotropicly to remove the conductive sidewall on the top surface of the stack structure and on the substrate and to expose the second sacrificial layer.

5. The method of fabricating capacitor electrode of claim 4, further comprising:
before removing the first sacrificial layer and the second sacrificial layer, and after anisotropicly etching the conductive sidewall, forming a polysilicon layer on the top surface of the stack structure, on the substrate, on the conductive sidewall on the first sidewall, the second sidewall, the third sidewall and the fourth sidewall;
etching the polysilicon layer anisotropicly to remove the polysilicon layer on the top surface of the stack structure and on the substrate and to expose the second sacrificial layer;
performing a titled implantation process on the polysilicon layer on the first sidewall and on the second sidewall;
removing the polysilicon layer on the third sidewall and on the fourth sidewall; and
removing the conductive sidewall on the third sidewall and on the fourth sidewall.

6. The method of fabricating capacitor electrode of claim 1, further comprising:
after removing the first sacrificial layer and the second sacrificial layer, depositing a capacitor dielectric layer to cover the first conductive layer, the second conductive layer and the conductive sidewall; and
forming a third conductive layer to encapsulate the capacitor dielectric layer.

7. The method of fabricating capacitor electrode of claim 1, wherein the first conductive layer, the second conductive layer and the conductive sidewall are made of the same material.

8. The method of fabricating capacitor electrode of claim 1, further comprising forming a conductive region disposed in the substrate, a contact plug connecting to the conductive region electrically.

9. The method of fabricating capacitor electrode of claim 8, wherein the first conductive layer connects to the contact plug electrically.

10. The method of fabricating capacitor electrode of claim 8, wherein the conductive region is a drain of a transistor.

11. A capacitor electrode structure, comprising:
a first conductive layer having a first edge and a second edge;
a second conductive layer parallel to the first conductive layer and having a third edge and a fourth edge;
a first conductive sidewall contacting the first edge and the third edge so as to connect the first conductive layer to the second conductive layer electrically; and
a second conductive sidewall contacting the second edge and the fourth edge so as to connect the first conductive layer to the second conductive layer electrically.

12. The capacitor electrode structure of claim 11, further comprising a polysilicon layer covering the first conductive sidewall and the second conductive sidewall.

13. The capacitor electrode structure of claim 12, further comprising:
a capacitor dielectric layer covering the first conductive layer, the second conductive layer, the first conductive sidewall, the second conductive sidewall and the polysilicon layer; and
a fourth conductive layer encapsulating the capacitor dielectric layer.

14. The capacitor electrode structure of claim 11, further comprising:
a capacitor dielectric layer covering the first conductive layer, the second conductive layer, the first conductive sidewall, and the second conductive sidewall; and
a fourth conductive layer encapsulating the capacitor dielectric layer.

15. The capacitor electrode structure of claim 11, wherein the first conductive layer, the second conductive layer, the first conductive sidewall, the second conductive sidewall are made of the same material.

16. A capacitor structure, comprising:
a first capacitor electrode, comprising:
a first conductive layer;
a second conductive layer parallel to the first conductive layer; and
a conductive sidewall contacting the first conductive layer and the second conductive layer for connecting the first conductive layer to the second conductive layer electrically;
a capacitor dielectric layer covering the first conductive layer, the second conductive layer and the conductive sidewall; and
a second capacitor electrode encapsulating the capacitor dielectric layer.

17. The capacitor structure of claim 16, wherein a polysilicon layer is disposed on the conductive sidewall.

18. The capacitor structure of claim 17, wherein the capacitor dielectric layer covers the polysilicon layer.

19. The capacitor structure of claim 16, wherein the conductive sidewall, the first conductive layer and the second conductive layer are made of the same material.
